(19) United States
(12) Patent Application Publication
(10) Pub. No.: US 2026/0174015 A1
(43) Pub. Date: Jun. 25, 2026

(54) Floral Stem Extension Device

(71) Applicant: Eva Woods, Broadview, NM (US)

(72) Inventor: Eva Woods, Broadview, NM (US)

(21) Appl. No.: 19/293,200

(22) Filed: Aug. 7, 2025

Related U.S. Application Data
(60) Provisional application No. 63/736,000, filed on Dec. 19, 2024.

(51) Int. Cl. A01G 5/04; A47G 7/02

(52) U.S. Cl. CPC A01G 5/04; A47G 7/02

(57) ABSTRACT

A floral stem extension device is provided. The device is comprised of a body that may be in the form of an elongated, hollow shaft that may be cylindrical or tapered. A first end of the device comprises a conically flared funnel opening dimensioned to accept stems of various diameters and to align them within the body. The internal wall may be smooth or include grip elements such as radial fins, barbed ridges, circumferential steps, or elastomeric linings arranged in axial, spiral, or staggered configurations to retain irregular stem surfaces. The opposite end of the device terminates in a tapered insertion tip, which may be conical, pyramidal, chisel-shaped, or bullet-shaped, facilitating insertion into floral foam, soil, or structural bases. The external surface of the device may comprise a grip element such as longitudinal grooves, circumferential ridges, or a knurled finish to enhance tactile handling and frictional engagement.

### CROSS-REFERENCE TO RELATED APPLICATION

The present application claims priority to, and the benefit of, U.S. Provisional Application No. 63/736,000, which was filed on Dec. 19, 2024, and is incorporated herein by reference in its entirety.

### FIELD OF THE INVENTION

The present invention relates generally to the field of floral arrangements. More specifically, the present invention relates to a device designed to extend artificial or natural flower stems quickly and securely for easy placement into floral foam or other bases without the need for cutting, wiring, or taping. Accordingly, the present disclosure makes specific reference thereto. Nonetheless, it is to be appreciated that aspects of the present invention are also equally applicable to other like applications, devices, and methods of manufacture.

### BACKGROUND

Floral arrangements often require precise customization of stem lengths to achieve the desired aesthetic and structural balance. In both artificial and real flower arrangements, florists and manufacturers commonly work with stems of varying sizes, widths, and colors. However, modifying these stems to fit specific designs presents several challenges. Lengthening a stem typically involves sourcing a compatible used stem in terms of size and color, which can be a time-consuming and inefficient process. Moreover, when reconfiguring an existing arrangement, users must dismantle the structure by unwrapping wire or floral tape from used stems, followed by managing their storage. These steps introduce additional labor, complicate the workflow, and may result in material waste or damage to delicate floral components. Furthermore, inserting altered stems into floral foam can damage the foam, reducing its reusability and structural integrity. These limitations present inefficiencies in floral design operations, especially in high-volume or time-sensitive contexts such as event planning, retail display, and professional floral services. Consequently, there is a significant need for a reusable, efficient, and adaptable solution that simplifies stem modification and integration into floral media.

Therefore, there exists a long-felt need in the art for a floral stem extension device that enables quick and reusable extension of artificial and real flower stems without requiring manual cutting, wiring, or taping. There also exists a long-felt need in the art for a floral stem extension device that accommodates various stem lengths, diameters, and colors to ensure compatibility across a broad range of floral materials. Moreover, there exists a long-felt need in the art for a floral stem extension device that minimizes damage to floral foam and other anchoring media, thereby improving the longevity and stability of floral arrangements.

The subject matter disclosed and claimed herein, in one embodiment thereof, comprises a floral stem extension device. The device is comprised of a body that may be in the form of an elongated, hollow shaft that may be cylindrical or tapered. A first end of the device comprises a conically flared funnel opening dimensioned to accept stems of various diameters and to align them within the body. The internal wall may be smooth or include grip elements such as radial fins, barbed ridges, circumferential steps, or elastomeric linings arranged in axial, spiral, or staggered configurations to retain irregular stem surfaces. The opposite end of the device terminates in a tapered insertion tip, which may be conical, pyramidal, chisel-shaped, or bullet-shaped, facilitating insertion into floral foam, soil, or structural bases. The external surface of the device may comprise a grip element such as longitudinal grooves, circumferential ridges, or a knurled finish to enhance tactile handling and frictional engagement. In some embodiments, the device may further comprise one or more external fastening mechanisms such as snap-lock arms, deformable barbs, circumferential flanges, adhesive fasteners, or retaining clips to secure the device to various floral support structures.

In this manner, the floral stem extension device of the present invention accomplishes all the foregoing objectives and provides a device that allows for tool-free extension of flower stems, thereby eliminating the labor-intensive steps of cutting, taping, or wiring. The device accommodates a variety of stem types and sizes through adaptable geometry and internal retention features, ensuring compatibility with both artificial and natural flowers. Additionally, the tapered insertion tip and optional fastening mechanisms allow secure placement into floral foam or structural bases without causing damage, thereby preserving the reusability of these components. By addressing both operational efficiency and material compatibility, the floral stem extension device provides a practical and reusable solution that enhances the workflow and quality of floral arrangements across diverse applications.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a floral stem extension device. The device is designed for repeated use and rapid deployment in floral assembly, eliminating manual cutting, wiring, or taping of stems. The device reduces labor time, enhances presentation uniformity, and supports a wide range of stem types and diameters for various floral arrangements, including centerpieces, bouquets, wreaths, vertical displays, and wall-mounted designs.

The device is comprised of a body that may vary in length and color. The body is preferably an elongated, hollow shaft. The body preferably has a cylindrical or slightly tapered geometry to support compatibility with various floral stem diameters. An internal taper may be included to enhance axial retention of inserted stems.

A first end of the body terminates in an integrally formed, conically flared funnel opening, dimensioned to accommodate stems of various thicknesses and assist in centering and axial alignment. An interior wall of the body may be smooth or may include grip elements such as radial fins, barbed ridges, circumferential steps, or elastomeric linings. These elements may be arranged in axial, spiral, or staggered configurations to enhance engagement with irregular stem surfaces. An opposite end of the body terminates in a tapered insertion tip for facilitating insertion into floral foam, soil, or structured anchoring media. An external surface of the body may be comprised of grip elements to enhance handling and improve stabilization within the surrounding material. The body may further be comprised of one or more external fastening mechanisms for securing the device to a floral base, foam, or structural interface.

The invention also includes a method of use involving the insertion of a floral stem into the funnel opening, guiding and retaining the stem via internal taper and grip elements, followed by insertion of the tapered tip into an anchoring medium. A fastening mechanism may optionally be deployed to secure the body to the supporting structure.

Accordingly, the floral stem extension device of the present invention is particularly advantageous as it provides a device that allows for tool-free extension of flower stems, thereby eliminating the labor-intensive steps of cutting, taping, or wiring. The device accommodates a variety of stem types and sizes through adaptable geometry and internal retention features, ensuring compatibility with both artificial and natural flowers. Additionally, the tapered insertion tip and optional fastening mechanisms allow secure placement into floral foam or structural bases without causing damage, thereby preserving the reusability of these components. By addressing both operational efficiency and material compatibility, the floral stem extension device provides a practical and reusable solution that enhances the workflow and quality of floral arrangements across diverse applications and that overcomes the limitations of existing techniques and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a floral stem extension device of the present invention in accordance with the disclosed architecture;

FIG. 2 illustrates a perspective view of one potential embodiment of a floral stem extension device of the present invention in accordance with the disclosed architecture; and

FIG. 3 illustrates a flowchart of a method of using one potential embodiment of a floral stem extension device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a floral stem extension device that enables quick and reusable extension of artificial and real flower stems without requiring manual cutting, wiring, or taping. There also exists a long-felt need in the art for a floral stem extension device that accommodates various stem lengths, diameters, and colors to ensure compatibility across a broad range of floral materials. Moreover, there exists a long-felt need in the art for a floral stem extension device that minimizes damage to floral foam and other anchoring media, thereby improving the longevity and stability of floral arrangements.

The present invention, in one exemplary embodiment, is comprised of a floral stem extension device. The device enables repeated use and rapid deployment within floral assembly settings by removing the need for manual cutting, wiring, or taping of stems. Through this functionality, the device reduces labor requirements, increases presentation uniformity, and accommodates a broad range of stem types and diameters suitable for arrangements such as centerpieces, bouquets, wreaths, vertical installations, and wall-mounted displays.

The device is comprised of a body capable of variation in both length and color. The body is preferably an elongated, hollow shaft formed with a cylindrical or slightly tapered shape to ensure compatibility with diverse floral stem diameters. An internal taper may be incorporated to improve axial retention of inserted stems.

At one end, the body terminates in a conically flared funnel opening formed integrally to accept stems of varying thicknesses and assist in their centering and axial alignment. The interior wall of the body may be either smooth or comprised of grip elements such as radial fins, barbed ridges, circumferential steps, or elastomeric linings, which may be arranged in axial, spiral, or staggered configurations to secure irregular stem surfaces. The opposite end of the body terminates in a tapered insertion tip designed for ease of penetration into floral foam, soil, or other structured anchoring media. The external surface may be comprised of grip elements that improve handling and contribute to stabilization when the device is positioned. Additionally, the body may include one or more external fastening mechanisms configured to secure the device to a floral base, foam, or structural support.

The invention further comprises a method of use in which a floral stem is inserted into the funnel opening, guided and held in place by the internal taper and grip elements, then advanced until the tapered tip is inserted into an anchoring medium. A fastening mechanism may be engaged, if present, to ensure secure attachment to a structural interface.

As a result, the floral stem extension device described herein offers distinct advantages by enabling tool-free extension of flower stems, eliminating labor-intensive steps such as cutting, taping, or wiring. The adaptable geometry and internal retention features support a variety of stem sizes and types, both artificial and natural. Secure insertion into floral foam or other bases is achieved through the tapered tip and optional fastening mechanisms, reducing the risk of damage and maintaining the reusability of supporting materials. The combination of these features promotes operational efficiency and compatibility, providing a reusable and practical solution that improves the quality and workflow of floral arrangements while addressing limitations found in existing methods and devices.

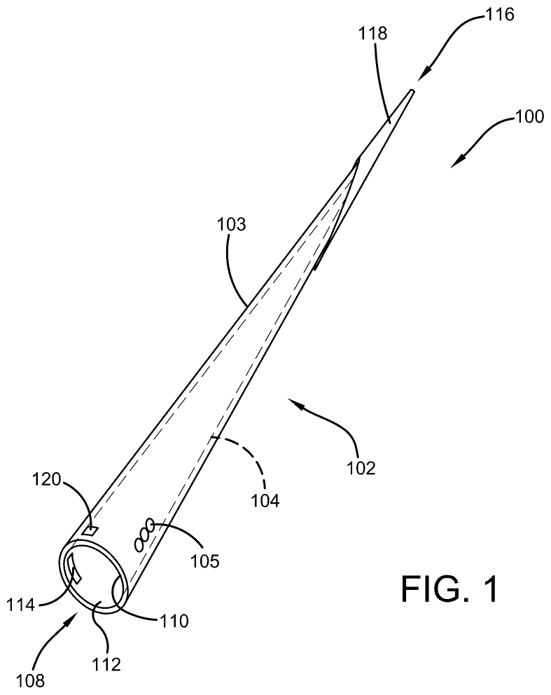

Referring initially to the drawings, FIG. 1 illustrates a perspective view of one potential embodiment of a floral stem extension device 100 of the present invention in accordance with the disclosed architecture. The device 100 is be designed to support repeated use and rapid deployment within floral assembly contexts. By eliminating the need for manual cutting, wiring, or taping of stems, the device 100 may reduce labor time and improve uniformity in floral presentation. The device 100 may accommodate a wide range of stem types and diameters, supporting both natural and synthetic materials. Potential applications may include but are not limited to centerpieces, bouquets, wreaths, vertical arrangements, and wall-mounted floral displays.

The device 100 is comprised of a body 102. The body 102 may be any length and color. The body 102 is preferably, but not limited to, in the shape of an elongated, hollow shaft formed from a lightweight, durable plastic material such as, but not limited to, polyethylene, polypropylene, polycarbonate, high-impact polystyrene, etc. In alternative embodiments, the body 102 may be made from biodegradable polymers, fiber-reinforced composites, or metallic alloys, depending on the application requirements, including environmental sustainability or increased structural strength.

The body 102 preferably has, but is not limited to, a generally cylindrical or tapered geometry to support compatibility with a broad range of floral stem diameters. In some configurations, the body 102 may include an internal taper 104 designed to enhance axial retention of inserted stems, as seen in FIG. 1.

A first end 108 of the body 102 may terminate in an integrally formed, conically flared funnel opening 110. The funnel opening 110 may be dimensioned to receive stems of various thicknesses and may serve to center and align each stem for reliable axial positioning within the body 102. The geometry of the funnel opening 110 may vary to include circular, elliptical, or polygonal profiles based on desired insertion dynamics or aesthetic integration.

An interior wall 112 of the body 102 may either be smooth or may be comprised of grip elements 114, as seen in FIG. 1. The grip elements 114 may include features such as, but not limited to, radial fins, barbed ridges, circumferential steps, elastomeric linings, etc. The grip elements 114 may be distributed in axial, spiral, or staggered configurations on the wall 112 to enhance engagement with irregular or non-uniform stem surfaces, including both natural and artificial variants.

The opposite end 116 of the body 102 may terminate in a tapered insertion tip 118, as seen in FIG. 1. The insertion tip 118 may be formed in a conical, pyramidal, chisel-shaped, or bullet-shaped configuration, depending on the composition and density of the floral base or anchoring medium. The tip 118 may be designed to facilitate insertion into media such as floral foam, soil, or structured bases typically found in floral arrangements.

An external surface 103 of the body 102 may be comprised of a grip element 105, as seen in FIG. 1. The grip element 105 may include surface textures such as, but not limited to, longitudinal grooves, circumferential ridges, a knurled finish, or a combination thereof. These textures may enhance tactile grip during handling and may also increase frictional engagement with the surrounding material, contributing to the stabilization of the device 100 upon placement.

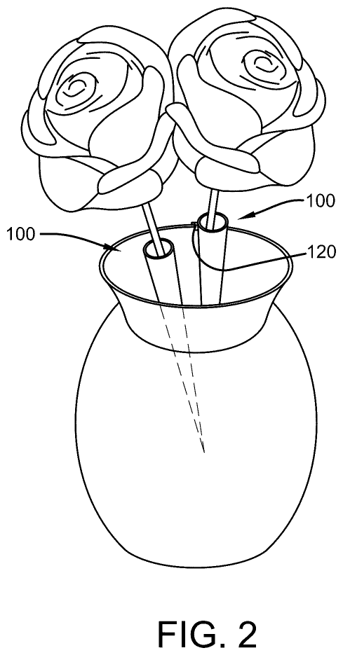

In certain embodiments, the body 102 may further be comprised of one or more external fastening mechanisms 120. These mechanisms 120 may be configured to secure the device 100 to a floral base, floral foam, a container lip, or other structural interfaces, as seen in FIG. 2. The fastening mechanisms 120 may include, but are not limited to, flexible snap-lock arms capable of engaging over container rims, deformable barbs suitable for embedding into compressible materials, circumferential flanges designed to inhibit axial displacement upon insertion, adhesive fasteners placed along the external surface for bonding to nearby supports, retaining clips designed to interface with apertures or slots in display containers, etc.

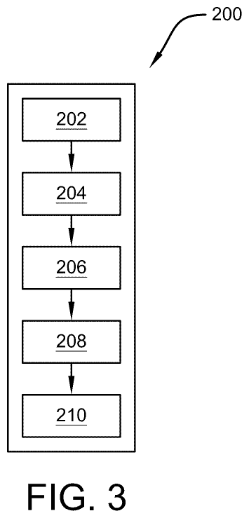

The present invention is also comprised of a method of using 200 the device 100, as seen in FIG. 3. First, a device 100 is provided that may be comprised of a body 102 having an internal taper 104, a funnel opening 110 at a first end 108, grip elements 114 on an interior wall 112, a tapered insertion tip 118 at an opposite end 116, at least one grip element 105 on an external surface 103, and at least one fastening mechanism 120 or any other combination of features mentioned supra [Step 202]. Then, at least one floral stem is inserted into the funnel opening 110 such that the stem is axially aligned and guided into the body 102 by the funnel geometry [Step 204]. Next, the stem is advanced along the body 102 wherein the internal taper 104 and grip elements 114 engage the stem to provide axial retention [Step 206]. Then, the tapered insertion tip 118 of the device 100 is inserted into a floral base or anchoring medium such as floral foam, soil, or a structured support platform [Step 208]. In an optional embodiment, a fastening mechanism 120 is deployed to further secure the body 102 to a container, foam, or structural interface, depending on the arrangement type [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “floral stem extension device” and “device” are interchangeable and refer to the floral stem extension device 100 of the present invention.

Notwithstanding the foregoing, the floral stem extension device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the floral stem extension device 100 as shown in the FIGS. are for illustrative purposes only, and that many other sizes and shapes of the floral stem extension device 100 are well within the scope of the present disclosure. Although the dimensions of the floral stem extension device 100 are important design parameters for user convenience, the floral stem extension device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A floral stem extension device comprising:
a body comprised of:
an opening formed at the first end of the body and configured to receive and axially align a floral stem; and
an insertion tip.

2. The floral stem extension device of claim 1, wherein the body is comprised of a cylindrical body.

3. The floral stem extension device of claim 1, wherein the body is comprised of a tapered body.

4. The floral stem extension device of claim 1, wherein the insertion tip is comprised of a conical insertion tip, a pyramidal insertion tip, a chisel-shaped tip, or a bullet-shaped tip.

5. The floral stem extension device of claim 1, wherein the body is comprised of a fastening mechanism.

6. The floral stem extension device of claim 5, wherein the fastening mechanism is comprised of a flexible snap-lock arm, deformable barb, circumferential flange, adhesive fastener, or retaining clip.

7. The floral stem extension device of claim 1, wherein the body is comprised of an internal taper.

8. The floral stem extension device of claim 1, wherein the opening is comprised of a funnel opening.

9. A floral stem extension device comprising:
a body comprised of:
an opening formed at the first end of the body and configured to receive and axially align a floral stem;
an interior wall comprised of a first grip element; and
an insertion tip.

10. The floral stem extension device of claim 9, wherein the first grip element is comprised of a radial fin, a barbed ridge, a circumferential step, or an elastomeric lining.

11. The floral stem extension device of claim 9, wherein the body is comprised of a second grip element on an external surface of the body.

12. The floral stem extension device of claim 11, wherein the second grip element is comprised of a longitudinal groove, a circumferential ridge, or a knurled finish.

13. The floral stem extension device of claim 9, wherein the body is comprised of a fastening mechanism.

14. The floral stem extension device of claim 13, wherein the fastening mechanism is comprised of a flexible snap-lock arm, deformable barb, circumferential flange, adhesive fastener, or retaining clip.

15. The floral stem extension device of claim 9, wherein the first grip element is positioned in an axial orientation on the interior wall.

16. The floral stem extension device of claim 9, wherein the first grip element is positioned in a spiral orientation on the interior wall.

17. The floral stem extension device of claim 9, wherein the first grip element is positioned in a staggered orientation on the interior wall.

18. The floral stem extension device of claim 9, wherein the body is comprised of an internal taper.

19. The floral stem extension device of claim 9, wherein the opening is comprised of a funnel opening.

20. A method of using a floral stem extension device, the method comprising the following steps:
providing a floral stem extension device comprised of a body having an opening at a first end and an insertion tip at an opposite end;
inserting a floral stem into the opening such that the stem is axially aligned and guided into the body;
advancing the floral stem along the body; and
inserting the insertion tip of the body into a floral base or an anchoring medium.
